(19) United States
(12) Patent Application Publication
(10) Pub. No.: US 2004/0208594 A1
(43) Pub. Date: Oct. 21, 2004

(54) Method for modifying the operating conditions of an electronic device comprising an infrared detection system

(76) Inventor: Daniel Dutheil, Meshers (FR)

Correspondence Address: GREENBLUM & BERNSTEIN, P.L.C., 1950 ROLAND CLARKE PLACE, RESTON, VA, 20191, US

(21) Appl. No.: 10/484,439

(22) PCT Filed: Jul. 30, 2002
(86) PCT No.: PCT/FR02/02725

(30) Foreign Application Priority Data
Aug. 3, 2001 (FR) 0110425

(51) Int. Cl. H04B 10/00

(52) U.S. Cl. 398/118; 398/106

(57) ABSTRACT

The invention concerns a device for modifying the operating conditions of an electronic component comprising an infrared detection system (3-4) which consists in emitting, besides the usual detection signal, a second low-power signal which can only be reflected via a passive reflector (5) located closer to the detection assembly.

The present invention relates to a method for enabling one to intervene in the operation of an electronic device comprising an infrared detection system, such as an electronically controlled tap, for example.

Such a tap comprises means for detecting the presence of a user and means for initiating a predetermined water flow cycle.

The device transmits an invisible infrared signal which, by reflecting on the user, generates a control signal that initiates the cycle, said device being controlled by a microcontroller (such as a microprocessor incorporating a temporary memory) associated with an EEPROM (ROM memory).

Generally speaking, these devices have a plurality of operating cycles determined by parameters that are prerecorded in the EEPROM. These parameters vary considerably and can relate to the detection distance, the cycle initiation instant, rinsing time, etc.

Until now, the user, when installing such a device, selected the initial cycle and could not change it thereafter, except by physically intervening in the electronic circuitry after opening a box, with all the risks that this involved.

The problem to be solved therefore consists of being able to modify the operating cycle of the apparatus without physically acting on the latter.

Since the device comprises an infrared signal receiver, an intervention method can be designed, which consists of controlling the cycle modification using a remote control similar to the one used to change channels on a television set.

Experimentation has shown that this solution cannot be satisfactorily applied to the present system. Indeed, it appears that keeping such an apparatus, which is still expensive, is not justified for a very episodic use:once the cycle has been selected during installation by the user, the latter only rarely needs to modify it. In fact, when this occurs, it is not certain that the remote control will still be working (dead battery). Added to this is the inconvenience that the system in which one is supposed to intervene must be “on standby” in order to be able to receive the information coming from the remote control at any time. This requirement increases the electric consumption of the systems, and it is a serious drawback, knowing that the latter, for reasons related to ease of implementation and safety, are supplied by batteries.

European Patent Application No. 940507 describes a device that attempts to resolve the aforementioned problem.

The means used derive from the well known phenomenon according to which the intensity of the optical signal reflected is higher as the obstacle is close to the receiver.

As a result, the electronic device for controlling the tap, described in the aforementioned application, is equipped with a timer which, after evaluating that a receiving signal has remained constant at a high level for a certain, switches said device from the “normal” operating mode to the so-called “communication” operating mode, which mode allows modifying the operating cycle by a judicious programming if, under particular conditions, the device determines the presence of a high level receiving signal.

In practice, the aforementioned document envisions keeping the hand relatively close to the transmitter and receiver, at a distance on the order of 5-10 centimeters for 10 seconds.

Such a device appears not to be reliable for a user can inadvertently disturb the operation of the tap whose opening for the water output is generally located at a distance from the detection device whose value is comprised within the range indicated hereinabove.

The method of the invention, which overcomes these drawbacks, is characterized in that the system transmits, in addition to the usual detection signal, a second, low-power signal which cannot be reflected by the user under normal conditions of use, and in that said signal can only be reflected when a passive reflector is positioned in the closest proximity to the transmitter-receiver assembly.

This reflector can be constituted by an ellipsoidal reflective object which the user brings in the closest proximity to the tap, for example, so as to cover the transmitter-receiver assembly.

The system is programmed so as to interrupt the normal operation of the apparatus as soon as it ascertains the return of this low-power signal:the apparatus goes into the communication mode. It is the time during which the reflector remains in place that determines the passage into the communication mode.

According to the invention, the detection signal is constituted by the periodical alternation of two pulse trains, the one of normal power for detecting the presence of a user, and the other of very low power requiring the use of a special reflector.

In the annexed drawing

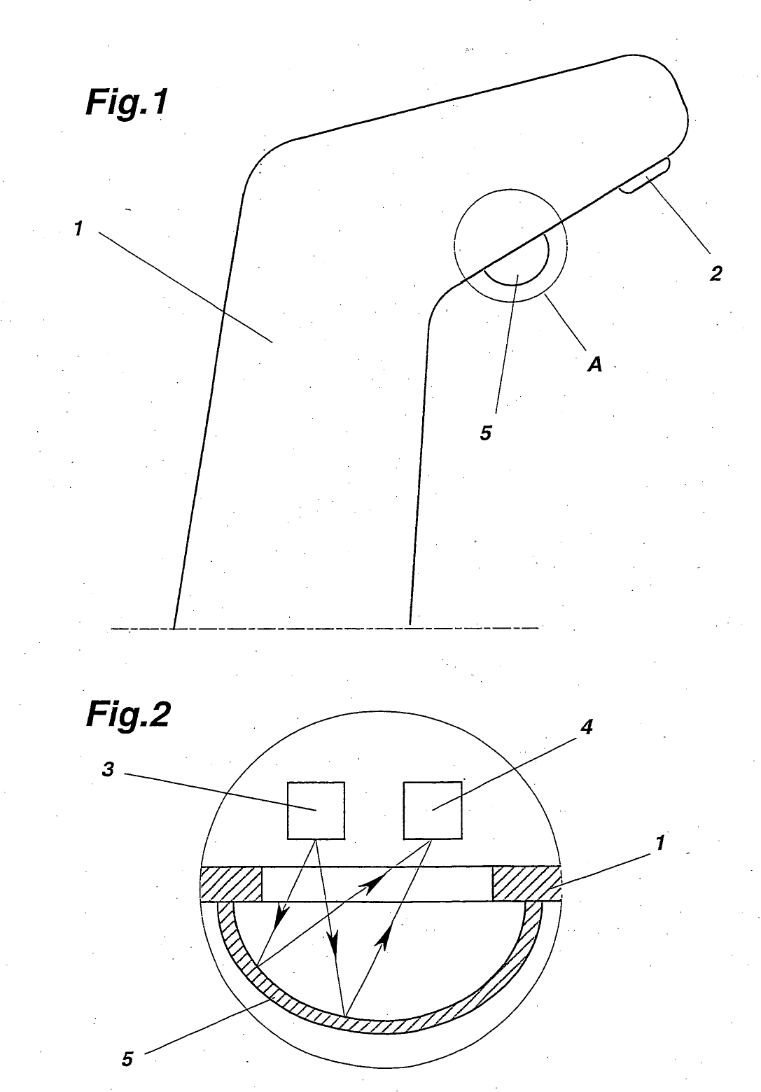

FIG. 1 is a schematic view of a tap, and

FIG. 2 is a cross-sectional view, on a larger scale, of the detail A of FIG. 1.

In reference to the drawing, it is seen that 1 is a usual tap comprising an opening 2 for water output, a transmitter 3 and a receiver 4.

According to the invention, the low-power signal is returned to the receiver via a reflector 5, which the manager places in contact with the tap when he wishes to switch to the communication mode.

This small reflector can take the shape of an ellipsoid, and can be metallic or made of a plastic material coated with a layer of reflective material.

The device is completed by a light source, such as a diode, which blinks when the device is in the communication mode, the type of blinking corresponding to a predetermined cycle. Thus, if the device has four possible cycles, the diode will blink in four different ways.

From the moment that the device is in the communication mode, the device increments the cycle by 1 each time that the reflector is in the position shown in the drawing, which means that if the four possible cycles are referenced by numbers 1-4, and the blinking mode corresponds to the cycle No. 3, for example, a passage of the reflector will activate the cycle No. 4, a next passage will activate the cycle No. 1, and so on. At each passage, the blinking of the diode will be modified to adopt the blinking mode characterizing the cycle activated.

If the receiver does not receive any signal, for a certain period of time, the device switches to the normal mode.

Each cycle is defined by parameter values that are determined initially and recorded in the EEPROM.

The problem to be solved also consists of communicating with the device for modifying the value of these parameters.

According to the invention, one uses an infrared transmission-reception head connected to the serial port of a micro-computer, the transfer of the information from the device to the computer, or vice versa, only being possible when the device has switched to the communication mode via the use of the reflector 5.

As for the selection of the cycle, the absence of a signal for a certain period of time authorizes the device to switch to the normal mode. Such a state can also be obtained by sending an order from the computer.

Naturally, from the moment that the device switches to the communication mode, the main function of the device is blocked:the water flow is stopped in the case of a tap.

1. Method for intervening in the operation of an electronic device comprising an infrared detection system (3-4) consisting of emitting, in addition to the usual detection signal, a second, low-power signal which can only be reflected via a passive reflector (5) located in the closest proximity to the detection assembly.

2. Method according to claim 1, according to which the detection signal is constituted by the periodical alternation of two pulse trains, the one of normal power, and the other of very low power requiring the use of the passive reflector in order to be reflected.

3. Method according to claim 1, characterized in that the reflector (5) is constituted by an ellipsoidal reflective object.

4. Method according to claim 1, characterized in that it is coupled to a light source, such as a diode, whose blinking mode characterizes the cycle activated.

5. Method according to claim 1, consisting of communicating with the device via an infrared transmission-reception head connected to the serial port of a computer.
